(19) United States
(12) Patent Application Publication
(10) Pub. No.: US 2004/0105226 A1
(43) Pub. Date: Jun. 3, 2004

(54) [COMPUTER CASE WITH SLIDING PANEL]

(76) Inventor: Shyh-Dar Geeng, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/605,601

(22) Filed: Oct. 13, 2003

(30) Foreign Application Priority Data
Oct. 11, 2002 (TW) 91216162

(51) Int. Cl. G06F 1/16

(52) U.S. Cl. 361/683

(57) ABSTRACT

A computer case structure with a sliding panel thereon for accommodating a host computer is provided. The host computer has input/output device slots and an optical system installed in one of the slots. The computer case comprises a sliding panel, a driving device, a liquid crystal module and a controlmechanism, wherein the sliding mechanism coupled between the sliding panel and the computer case for driving the sliding panel switched between predetermined first terminal and second terminal positions. The optical system is substantially enclosed inside the computer case after the control mechanism is actuated to drive the sliding panel being switched to the first terminal position. After the control mechanism is actuated again, the sliding panel is driven to switch back to the second terminal position such that the front panel of the optical system is substantially exposed so as to facilitate the tray of the optical system to be moved in and out of the computer case. The liquid crystal module is attached to the surface of the sliding panelfor showing current operating states of the optical system or multimedia states playing by the host computer.

### CROSS REFERENCE TO RELATED APPLICATIONS

This application claims the priority benefit of Taiwan application serial no. 91216162, filed Oct. 11, 2002.

### BACKGROUND OF INVENTION

1. Field of Invention

The present invention relates to a computer case with a sliding panel. More particularly, the present invention relates to a computer case having a sliding panel that can be electrically driven and have a liquid crystal display on the sliding panel.

2. Description of Related Art

The twenty-first century can be regarded as the beginning of yet another electronic revolution. Due to the rapid expansions of the electronics industry, countless electronic devices and computers are developed and used in many areas including, for example, the manufacturing industry, household products, information broadcasting, telecommunication and the public media. Aside from ease of use, modern people also demand electronic products to be well designed and aesthetically appealing. Hence, newer generations of computers must be easily used and must have an attractive appearance and a definite substantial feeling.

FIG. 1 is a perspective view of a conventional desktop computer case. A conventional desktop computer system 100 is housed inside a computer case 102. In general, the computer case 102 houses most of the computer components needed for the normal operation including, for example, a main board, a central processing unit (CPU), a few memory units, a few peripheral interfaces such as a display interface, an acoustic effect output interface and a few input/output devices such as a floppy disk, a hard disk and a compact disk player. The computer case 102 is what we can see from the outside. The computer case 102 has a number of slots 104 for installing input/output devices including a floppy disk, a hard disk and a compact disk player. As shown in FIG. 1, a compact disk player 106 is installed within one of the slots 104 in the front panel of the computer case 102. At present, some of the computer host machines have protective covers (not shown). However, these covers are often manually operated. Moreover, to activate a peripheral device such as activating a compact disk player to play music, a particular button on the keyboard is pressed or a special icon is called up from the Windows operating system. The current operating state of the computer is reported on a monitor screen.

Nowadays, the audio-video devices inside the computer for playing multimedia are capable of producing audio and video information on par with the ones produced by formal audio-video equipments. Hence, some computer users are now using their own computer system to play back musical recordings or movies. However, the major drawback is that a conventional computer usually provides less user-friendly interfaces than a stereo system or an audio/video player, which significantly inconveniences users while operating.

### SUMMARY OF INVENTION

To overcome the aforementioned problems, the present invention discloses a computer having a sliding panel to facilitate a user from easily placing or removing an optical disc from associated optical system such as a compact disk player or optical disk drive. In the embodiment, a computer case comprises a plurality of slots for installing input/output devices and anoptical system installed in one of the input/output device slots. The computer case further comprises a sliding panel, a driving device, a liquid crystal module and a control mechanism. The sliding panel is coupled to the computer case via a sliding mechanism so as to constrainthe sliding movements between predetermined first and second terminal positions. The optical system is substantially enclosed inside the computer case after the control mechanism is actuated to drive the sliding panel being switched to the first terminal position. When the control mechanism is actuated again, the sliding panel is driven to switch back to the second terminal position such that the front panel of the optical system is substantially exposed so as to facilitate the tray of the optical system to be moved in and out of the computer case.

In one embodiment, the computer case further comprises a plurality of buttons formed on the computer case or on the sliding panel for controlling functions of the panel and the optical system. The sliding mechanism coupling the sliding panel to the computer case comprises a sliding groove and a sliding element, wherein one of the sliding groove and sliding element is formed on the computer case and the other one is formed on the sliding panel. In the embodiment, the sliding element is inserted into the sliding groove. The driving device comprises a driving motor and a gearwheelthat one of the motor and a gearwheel is formed on the computer case and the other one is formed on the sliding panel. The liquid crystal module comprises a touch-sensitive liquid crystal panel. The liquid crystal module may have an additional protective cover. In one embodiment, the backside of the sliding panel can be shaped into a circular arc so that the sliding panel is able to slide along a circular arc relative to the computer case.

The liquid crystal module on the sliding panel may be used to display the current operating states of the optical system or multimedia states including the sound volume, the playback time and so on playing by the host computer. The second buttons can be directly used to initiate playback or control the sound volume of the playback. Hence, the embodiment is able to incorporate all the advantages of using an audio/audio-video compact disk system into a personal computer.

In one embodiment, the optical system is enclosed to hide behind the sliding panel during a playback, a normal operation or at the end of all operations. Hence, the computer case has the appearance of a hi-fi stereo system. When the host computer is combined with relevant firmware or related components, the host computer may be operated like an audio or audio-video playback system.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a perspective view of a conventional desktop computer case.

FIG. 2 is a perspective view of a computer case with a sliding panel moved to the first terminal position according to one preferred embodiment of this invention.

FIG. 3 is a perspective view of a computer case with a sliding panel moved to the second terminal position according to one preferred embodiment of this invention.

FIG. 4 is a diagram showing a driving module inside the computer case for moving the sliding panel according to this invention.

FIG. 5 is a diagram showing a sliding mechanism for linking the sliding panel to the computer case according to this invention.

FIG. 6 is a diagram showing another driving module inside the computer case for moving the sliding panel according to this invention.

FIG. 7 is a diagram showing another sliding mechanism for linking the sliding panel to the computer case according to this invention.

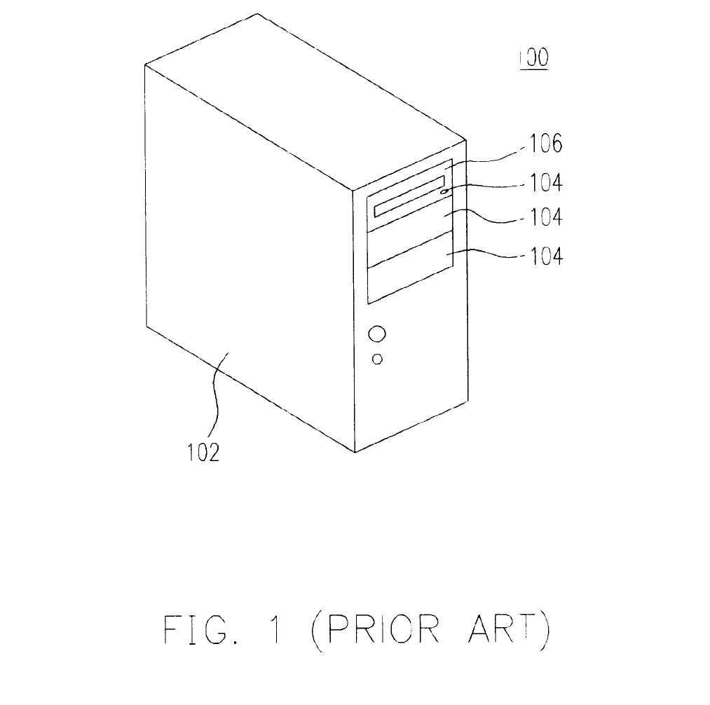

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

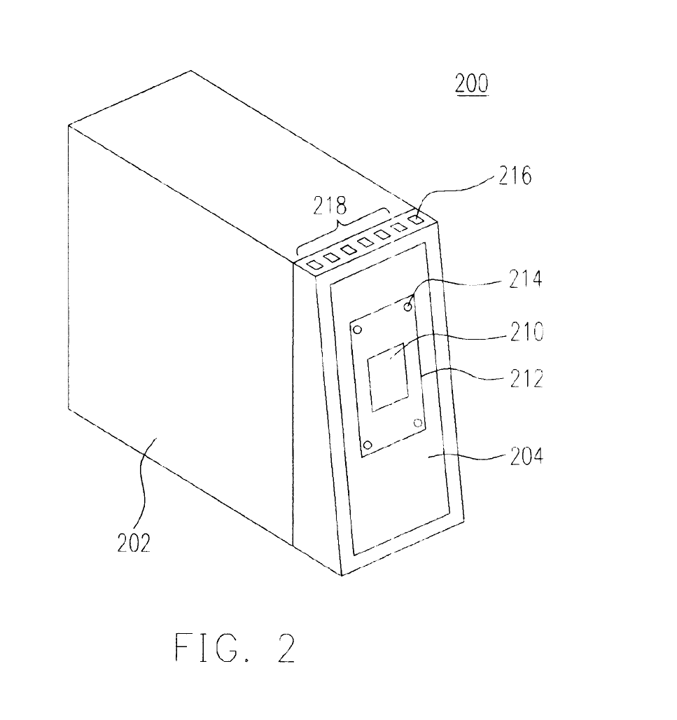

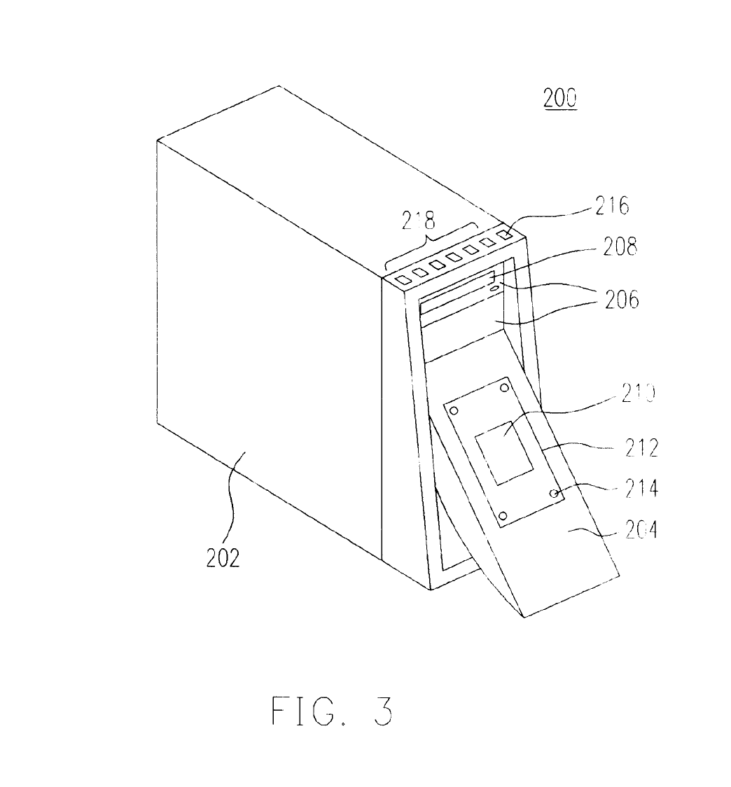

FIG. 2 is a perspective view of a computer case with a sliding panel stayed at the first terminal position according to one preferred embodiment of this invention. FIG. 3 is a perspective view of a computer case with a sliding panel switched to the second terminal position according to one preferred embodiment of this invention. As shown in FIGS. 2 and 3, the host system 200 is integrated inside a computer case 202 that houses all the major computer components including a main board, a central processing unit (CPU), a few memory units and a few peripheral interfaces such as a display interface, an acoustic effect interface and an input/output device such as a floppy disk, a hard disk and a compact disk player. The computer case 202 encompasses a plurality of slots 206 for accommodating input/output devices. Anoptical system 208 is installed in one of the input/output device slots 206. However, the most top one of the slots 206 is suggested to install the optical system in the embodiment such that the front panel of the housed optical system 208 can be exposed to facilitate a tray of the optical system to be moved in and out of the optical system when the sliding panel is at the second terminal position, therefore a user may deposit or remove an optical disk from the tray.

A sliding panel 204 is engaged to the computer case 202 through a sliding mechanism. In other words, the sliding panel 204 may move relative to the computer case 202, and the movements of the sliding panel 204 is constrained between thepredetermined first and second terminal positions. As shown in FIG. 2, the optical system 208 is completely housed inside the computer case 202 when the sliding panel 204 reaches the first terminal position. Conversely, as shown in FIG. 3, the front panel of the compact disk player 208 is substantially exposed such that the tray may be moved in and out of the of the optical system 208 for the purpose of depositing or removing an optical disc when the sliding panel 208 reaches the second terminal position. The disclosed structure according to this invention may incorporate a first button 216 to control the movements of the sliding panel 204 relative to the computer case 202. Although the first button 216 is formed on the computer case 202 as shown in FIGS. 2 and 3, however,the first button 216 may be positioned on the sliding panel 204 as applications. Furthermore, through the hardware setup, the first button 216 can be used to control the slidingmovements of the sliding panel 204 and the tray movements operations simultaneously. In other words, the trayof the compact disk player 208 will be ejected(i.e. moved out from the optical system) after the sliding panel 204 is fully opened (at the second terminal position) once the first button 216 is pressed. The application with the same Applicant as the present invention entitled “Method for operating the tray of an optical disk system” discloses detailed schemes of how to simultaneously control the aforementioned sliding movements and moving in/out operations. However, to prevent any jamming while the tray is moving, a sensing device for detecting current position of the sliding panel 204 may be installed for monitoring purpose.

A liquid crystal module 210 is also mounted on the sliding panel 204. The liquid crystal module 210 shows the current states of the operating optical system 208 such as playback, stop, pause, sound level and time. The liquid crystal module 210 may even be used to show dynamic images or the fluctuation of an equalizer or serve as a bedside sound system with a digital alarm clock. Furthermore, light-emitting diodes of different colors can be set as the background lighting within the liquid crystal module 210 so that a different background color is displayed when the current operating state changes.

The playback controls and the volume level adjustments in the entire audio-video system can be achieved through the second buttons 218. Obviously, the second buttons 218 can be installed on the sliding panel besides the computer case 202. Moreover, a touch-sensitive liquid crystal module may be employed so that the second buttons can be implemented as icons on the touch-sensitive screen. The second buttons 218 serve many functions such as initiating a playback, stopping a playback, pausing during a playback, adjusting the sound level during a playback, rapid forwarding, rapid reversing and so on. In addition, through the firmware design, the audio-video system may bypass the controlsfrom the operating system. In other words, the audio-video system may be directly actuated by means ofa predetermined one of the second buttons 218 without going through the long diagnostic procedures for starting anoperating system so that the audio-video system incorporated within the host computer is very similar to an ordinary audio-video playback system. For the sake of simplification, detail description of how to configure associated firmware is omitted here since any ordinary person having skills in the art knows how to implement this. In this invention, if an ordinary liquid crystal module, that is, one without a touch-sensitive function, is used, a protective cover 212 may be fastened onto the surface of the liquid crystal module 210 using a few fasteners 214. The protective cover 212 may protect the liquid crystal module 210 and render the sliding panel more appealing aesthetically.

FIG. 4 is a diagram showing a driving device inside the computer case 202 for moving the sliding panel according to this invention. The sliding panel 204 can be driven electrically through a driving setup as shown in FIG. 4. As shown in FIG. 4, the backside of the sliding panel 204 has a plurality of gear teeth lining its arcing edge. An electric motor 232 is engaged with the gear teeth 230 through a gearwheel. On pressing down the first button, the electric motor 232 is triggered to move the sliding panel 204 relative to the computer casing 204. However, if the sliding panel 204 is manually operated in another embodiment, an inertial wheel should replace the gearwheel on the shaft of the electric motor 232. In the manually operated sliding panel, the inertial wheel serves as a buffer and a stabilizer for the sliding motion.

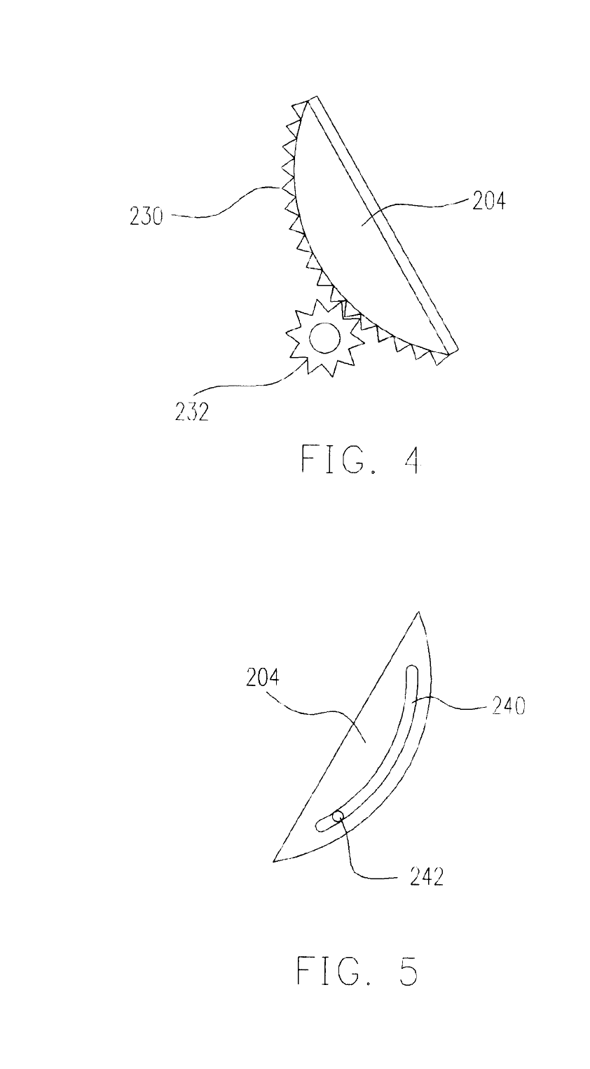

FIG. 5 is a diagram showing a sliding mechanism for linking the sliding panel to the computer case 202 according to this invention. In this invention, the sliding panel 204 links up with the computer case 202 in such a way that the sliding panel 204 moves in an arc. In fact, the back of the sliding panel 204 is shaped into an arc for engaging with a sliding device. The sliding connection is similar to the one shown in FIG. 5. The sidewall of the sliding panel 204 has a sliding groove 240. One end of a sliding element 242 such as a slot pin is attached to the computer case 202 while the other end is inserted into the sliding groove 240.

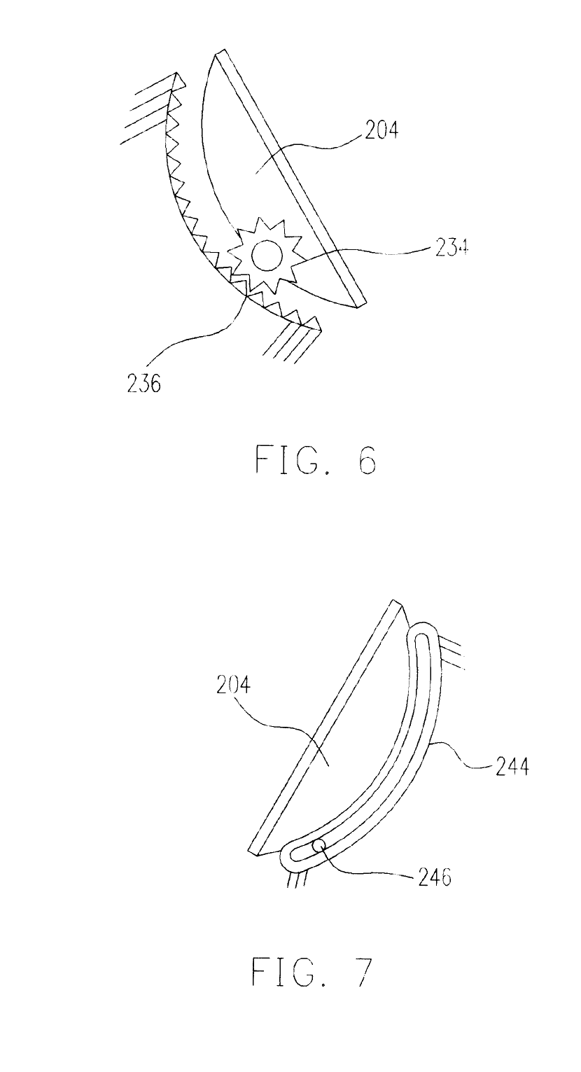

FIG. 6 is a diagram showing another driving device inside the computer case 202 for moving the sliding panel 204 according to this invention. The location of attachment for the sliding element and the sliding groove and the location of attachment for the electric motor with gearwheel as shown in FIGS. 4 and 5 can be reversed. As shown in FIG. 6, an element having an arc lined with gear teeth 236 is attached to the computer case 202 while an electric motor 234 with a gear teeth attached to its shaft is attached to the sliding panel 204.

FIG. 7 is a diagram showing another sliding mechanism for linking the sliding panel 204 to the computer case 202 according to this invention. As shown in FIG. 7, a bracket with a sliding groove 244 thereon is attached to the computer case 202. Meanwhile, one end of a sliding element 246 is attached to a sidewall of the sliding panel 204 and the other end of the sliding element 246 is inserted into the sliding groove 244. Each sliding structure as shown in FIG. 5 and FIG. 7 may cooperate with any driving device as shown in FIGS. 4 and 6.

Anyone familiar with sliding structures should notice that the aforementioned sliding mechanism is not the only type that can be deployed. Other types of sliding structures should also be included within the spirit of this invention. In addition, the driving device can also be implemented in a variety of ways. In this invention, the sliding panel and the computer case has an arc-shaped engagement that can be driven electrically or manually. However, the electrically driven sliding panel is not limited to an arc-shaped engagement. A linear sliding mechanism may also be deployed for moving the sliding panel up or down in a vertical direction. In other words, a rack and pinion type of sliding mechanism can be used to link the sliding panel with the computer case. Furthermore, the optical system may be any commonly used optical disk system that may display audio/video, such as a compact disk-read only memory (CD-ROM)drive and a digitalversatile disk-read only memory (DVD-ROM) drive. Nevertheless, the present invention can be applied to an optical recording apparatus, for example, a compact disk-recordable (CD-R) drive, a compact disk-rewritable (CD-RW) drive, a digitalversatile disk-recordable (DVD-R) drive, a digitalversatile disk-rewritable (DVD-RW) drive and a digitalversatile disk-random access memory (DVD-RAM) drive.

In summary, major advantages of this invention include at least: 1. The disclosed sliding panel may enclosed an optical system or expose front panel of the optical system such that the tray of the optical system may be moved in and out for loading an optical disc for playing purpose. The movements of both the optical system tray and the sliding panel may be controlled by means of a unique control mechanism such as a button on the computer case so as to establish a hi-fi stereo system based on a general purpose computer system. 2. The optical system is hidden behind the sliding panel during a playback, a normal operation or at the end of an operation. Therefore, the computer has the appearance of a hi-fi stereo system. When the computer is interfaced with firmware designs, the computer can be regarded as an integrative system that comprises a personal computer, an audio system and an audio-video playing system. 3. The liquid crystal module can be used to display the current operating states of the compact disk player or that of the audio-video system such as the volume level and the playback duration. Moreover, the second buttons can be used to initiate any playback or adjust the volume level of the compact disk player directly. Through the firmware design, the audio-video system may operate without going through the operating system. Hence, this invention actually integrates an audio and audio-video playback system into a personal computer. 4. The sliding panel may be used to display the current operating states of the audio-video playback system. User interfaces are simplified since monitors by means of the computer screen is unnecessary.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A computer case structure for accommodating a host computer, the host computer comprising at least a plurality of slots for installing input/output devices and anoptical system installed in one of the slots, the computer case comprising:
a sliding mechanism;
a sliding panel coupled to the computer case throughthe sliding mechanism such that the sliding panel may sliding relative to the computer case between a first terminal position and a second terminal position such that the optical systemmay besubstantially enclosedinside the computer case when the sliding panel is at the first terminal position and a front panel of the optical system is exposed from the computer case to facilitate a tray of the optical system from moving in and out of the optical system when the sliding panel is at the second terminal position; and
a driving device mounted between the computer case and the sliding panel for moving the sliding panel relative to the computer case.

2. The computer case structure of claim 1 wherein the sliding mechanism linking the sliding panel with the computer case comprises a sliding groove and a sliding element that the sliding element is inserted into the sliding groove, wherein the sliding groove is formed on the computer case and the sliding element is attached to the sliding panel.

3. The computer case structure of claim 1 wherein the sliding mechanism linking the sliding panel with the computer case comprises a sliding groove and a sliding element thatthe sliding element is inserted into the sliding groove, wherein the sliding groove is formed on the sliding panel and the sliding element is attached to the computer case.

4. The computer case structure of claim 1 wherein the driving device comprises an electric motor with a gear wheel that meshes with a rack with gear teeth lining a surface of the rack,wherein the electric motor is attached to the computer case and the rack is attached to the sliding panel.

5. The computer case structure of claim 1 wherein the driving device comprises an electric motor with a gear wheel that meshes with a rack with gear teeth lining a surface of the rack, wherein the electric motor is attached to the sliding panel and the rack is attached to the computer case.

6. The computer case structure of claim 1 wherein a back of the sliding panel has an arc-shaped body such that the sliding panel slides along a circular arc relative to the computer case.

7. The computer case structure of claim 1 further comprising a liquid crystal module mounted on the sliding panel for showing current operating states of the optical system or multimedia states playing by the host computer.

8. The computer case structure of claim 7 wherein the liquid crystal module comprises a touch-sensitive liquid crystal display.

9. The computer case structure of claim 1 further comprising a control mechanism for controlling movements of the sliding panel and the tray of the optical system.

10. The computer case structure of claim 9 wherein the tray of the optical system is moved out from the computer case after the sliding panel being switchedfrom the first terminal position to the second terminal position when the control mechanism is actuated.

11. The computer case structure of claim 9 wherein the tray of the optical system is movedinto the computer case before the sliding panel being switchedfrom the second terminal position to the first terminal position when the control mechanism is actuated again.

12. The computer case structure of claim 9 further comprising a sensing device for monitoring a position of the tray so as to prevent jamming while the tray is moving.

13. A computer case structure for accommodating a host computer, the host computer comprising a plurality of slots for installing input/output devices and an optical system installed in one of the slots, the computer case comprising:
a sliding panel coupled to the computer case through a sliding mechanism, wherein the sliding panel slides relative to the computer case between a first terminal position and a second terminal position such that the optical system is substantially enclosed inside the computer casewhen the sliding panel is at the first terminal position, and a front panel of the optical system is substantially exposed from the computer case to facilitate a tray of the optical system from moving in and out of the optical system when the sliding panel is at the second terminal position; and
a control mechanism for controlling movements of the sliding panel and the tray of the optical system, wherein the control mechanism is actuated to make the tray of the optical system being moved out from the computer case after the sliding panel being switchedfrom the first terminal position to the second terminal position, and when the control mechanism is actuated again, the tray of the optical system is movedinto the computer case before the sliding panel being switchedfrom the second terminal position to the first terminal position.

14. The computer case structure of claim 1 3wherein the sliding mechanism linking the sliding panel with the computer case comprises a sliding groove and a sliding element that the sliding element is inserted into the sliding groove, wherein the sliding groove is formed on the computer case and the sliding element is attached to the corresponding sliding panel.

15. The computer case structure of claim 13 wherein the sliding mechanism linking the sliding panel with the computer case comprises a sliding groove and a sliding element thatthe sliding element is inserted into the sliding groove, wherein the sliding groove is formed on the sliding panel and the sliding element is attached to the corresponding computer case.

16. The computer case structure of claim 13 wherein the driving device comprises an electric motor with a gear wheel that meshes with a rack with gear teeth lining a surface of the rack and the electric motor is attached to the computer case and the rack is attached to the sliding panel.

17. The computer case structure of claim 16 wherein when the electric motor is attached to the computer case,the rack is attached to the sliding panel, and when the electric motor is attached to the sliding panel, the rack is attached to the computer case.

18. The computer case structure of claim 13 wherein a back of the sliding panel has an arc-shaped body such that the sliding panel slides along a circular arc relative to the computer case.

19. The computer case structure of claim 13 further comprising a liquid crystal module mounted on the sliding panel for showing current operating states of the optical system or multimedia states playing by the host computer.

20. The computer case structure of claim 19 wherein the liquid crystal module comprises a touch-sensitive liquid crystal display.
